(19) United States
(12) Patent Application Publication
(10) Pub. No.: US 2002/0139246 A1
(43) Pub. Date: Oct. 3, 2002

(54) Multi-bed adsorption process for air purification

(76) Inventors: Ravi Kumar, Allentown, PA (US); Christopher Benjamin McIlroy, Basking Ridge, NJ (US); Robert Warren Schluter, New City, NY (US); John Pulsinelle, Milford, NJ (US); Michael J. Mitariten, Pittstown, NJ (US)

Correspondence Address: Philip H. Von Neida, Intellectual Property Dept., The BOC Group, Inc., 100 Mountain Ave., Murray Hill, NJ, 07974, US

(21) Appl. No.: 09/753,851

(22) Filed: Jan. 3, 2001

(51) Int. Cl. B01D 53/047

(52) U.S. Cl. 95/98

(57) ABSTRACT

Disclosed is a novel pressure swing adsorption (PSA) pre-purification process for a feed gas prior to its introduction into a cryogenic distillation unit. The PSA process uses in a multi-bed adsorbent system the steps, performed in a cyclical manner, of feed, blowdown, purge and repressurization. Optionally, a pressure equalization step is employed in the process. The resulting process provides for continual repressurization during the cycle and a constant flow rate of purified feed gas to the distillation unit.

### FIELD OF THE INVENTION

The present invention provides for a method for removing contaminating gas components from air. More particularly, the present invention provides for a multi-bed pressure swing adsorption (PSA) pre-purification unit (PPU) for removing water and carbon dioxide from air prior to its introduction into a cryogenic distillation unit.

### BACKGROUND OF THE INVENTION

Adsorption is well established as a unit operation for the production of pure gases, the purification of gases and their mixtures up-front, their further physical and/or chemical handling, and for the treatment of fluid waste streams. Purification and separation of atmospheric air comprises one of the main areas in which adsorption methods are widely used. For an increase of their efficiency, novel adsorbent formularies and processes of their utilization are being sought permanently.

One of the areas of strong commercial and technical interest represents pre-purification of air before its cryogenic distillation. Conventional air separation units (ASUs) for the production of nitrogen, N₂, and oxygen, O₂, and also for argon, Ar, by the cryogenic separation of air are basically comprised of two or at least three, respectively, integrated distillation columns which operate at very low temperatures. Due to these low temperatures, it is essential that water vapor, H₂O, and carbon dioxide, CO₂, is removed from the compressed air feed to an ASU. If this is not done, the low temperature sections of the ASU will freeze up making it necessary to halt production and warm the clogged sections to revaporize and remove the offending solid mass of frozen gases. This can be very costly. It is generally recognized that, in order to prevent freeze up of an ASU, the content of H₂O and CO₂ in the compressed air feed stream must be less than 0.1 ppm and 1.0 ppm or lower, respectively. Besides, other contaminants such as low-molecular-weight hydrocarbons and nitrous oxide, N₂O, may also be present in the air feed to the cryogenic temperature distillation columns, and they must as well be removed up-front the named separation process to prevent hazardous process regime.

A process and apparatus for the pre-purification of air must have the capacity to constantly meet the above levels of contamination, and hopefully exceed the related level of demand, and must do so in an efficient manner. This is particularly significant since the cost of the pre-purification is added directly to the cost of the product gases of the ASU.

Current commercial methods for the pre-purification of air include reversing heat exchangers, temperature swing adsorption, pressure swing adsorption and catalytic pre-purification techniques.

Reversing heat exchangers remove water vapor and carbon dioxide by alternately freezing and evaporating them in their passages. Such systems require a large amount, typically 50% or more, of product gas for the cleaning, i.e., regenerating of their passages. Therefore, product yield is limited to about 50% of feed. As a result of this significant disadvantage, combined with characteristic mechanical and noise problems, the use of reversing heat exchangers as a means of air pre-purification in front of ASUs has steadily declined over recent years.

In temperature swing adsorption (TSA) pre-purification of air, the impurities are removed from air at relatively low ambient temperature, typically at about (5-15)° C., and regeneration of the adsorbent is carried out at elevated temperatures, e.g., in a region of about (150-250)° C. The amount of product gas required for regeneration is typically only about (10-25) % of the product gas. Thus, a TSA process offers a considerable improvement over that of utilizing reversing heat exchangers. However, TSA processes require evaporative cooling or refrigeration units to chill the feed gas and heating units to heat the regeneration gas. They may, therefore, be disadvantageous both in terms of capital costs and energy consumption despite of being more cost-effective than the reversing heat exchangers' principle referred to above.

Pressure swing adsorption (PSA) (or pressure-vacuum swing adsorption (PVSA)) processes are an attractive alternative to TSA processes, for example, as a means of air pre-purification, since both adsorption and regeneration via desorption, are performed, as a rule, at ambient temperature. PSA processes, in general, do require substantially more regeneration gas than TSA processes. This can be disadvantageous if high recovery of cryogenically separated products is required. If a PSA air pre-purification unit is coupled to a cryogenic ASU plant, a waste stream from the cryogenic section, which is operated at a pressure close to ambient pressure, is used as purge for regenerating the adsorption beds. Feed air is passed under pressure through a layer of particles of activated alumina, to remove the bulk of H₂O and CO₂, and then through a layer of zeolite particles such as of the FAU structural type, e.g., NaX zeolite, to remove the remaining low concentrations of H₂ and CO₂. Arrangement of the adsorbent layers in this manner is noted to increase the temperature effects, i.e., temperature drops during desorption, in the PSA beds. In other configurations, only activated alumina is used to remove both H₂O and CO₂ from feed air. This arrangement is claimed to reduce the temperature effects.

It will be appreciated that, although many pre-purification methodologies based on PSA have been proposed in the literature, a few of those are actually being used commercially due to high capital costs associated therewith.

In general, known PSA pre-purification processes require a minimum of 25%, typically (40-50)%, of the feed as purge gas. As a result of having low adsorbent specific product, such processes have high capital cost. Reduction in capital costs of air pre-purification systems is particularly important when a large plant is contemplated. Therefore, it will be readily appreciated that, for large plants, improvements in pre-purification system operation can result into considerable cost savings.

### SUMMARY OF THE INVENTION

The present invention relates to a pressure swing adsorption process for removing carbon dioxide and water vapor from air prior to its introduction into a cryogenic distillation unit. This PSA pre-purification process is a multi-bed process where each bed is phased such that for intervals it is receiving feed gas, pressure equalized, blowdown, one or more bed purge and pressurization.

This process utilizes constant and continual repressurization throughout the cycle and does not vent purified feed gas to the atmosphere.

In an alternative embodiment, this cyclical PSA-PPU process is performed without a pressure equalization step.

### BRIEF DESCRIPTION OF THE DRAWINGS

FIG. 1 is a schematic cycle diagram representing a four bed PSA PPU cycle without a pressure equalization step.

FIG. 2 is a schematic cycle diagram representing a four bed PSA PPU cycle with a pressure equalization step.

FIG. 3 is a schematic cycle diagram representing a five bed PSA PPU cycle without a pressure equalization step.

FIG. 4 is a schematic cycle diagram representing a five bed PSA PPU cycle of FIG. 3 with a pressure equalization step.

FIG. 5 is a schematic cycle diagram representing a six bed PSA PPU cycle without a pressure equalization step. In this option 3 beds are always on feed.

FIG. 6 is a schematic cycle diagram representing a six bed PSA PPU cycle of FIG. 5 with a pressure equalization step.

FIG. 7 is a schematic cycle diagram representing a six bed PSA PPU cycle without a pressure equalization step. In this option only 2 beds are always on feed, but at times 3 beds are on purge.

FIG. 8 is a schematic cycle diagram representing a six bed PSA PPU cycle of FIG. 7 with a pressure equalization step.

FIG. 9 is a schematic cycle diagram representing a five bed PSA PPU cycle without a pressure equalization step.

### DETAILED DESCRIPTION OF THE INVENTION

This invention provides for a process for purifying air prior to its introduction into a cryogenic distillation facility. This process comprises a pressure swing adsorption process for removing carbon dioxide and water from feed air gas comprising introducing said gas through at least four beds of adsorbent so that each bed operates in phase and in a cyclical manner in that each bed undergoes in intervals receiving feed gas, pressure equalization, blowdown, purge and repressurization. This process has continuous repressurization during the complete cycle and does not vent purified feed gas prior to it being fed to the cryogenic facility.

As such, the process provides for feed of air at high pressure to at least two beds. The purified feed gas is also fed to the cryogenic distillation column at high pressure. One of the beds is blown down from the high feed pressure to pressure close to ambient levels. At least one of the beds at low pressure is purged (or regenerated) at low pressure using waste gas produced by the cryogenic distillation column. Lastly during the cycle the purged/regenerated bed is repressurized from ambient pressures to high feed pressure by using the high pressure product from the product produced by a bed in the first step.

Preferably this is a five bed process, however, anywhere from 4 or more beds can be employed in this PSA PPU process. These beds will contain an adsorbent material which will adsorb carbon dioxide and water. Activated alumina or silica gel may be employed to remove water and an X zeolite such as 13X may be used to remove carbon dioxide. Typically the X zeolite is an NaX zeolite with an Si/Al elemental ratio of the zeolitic phase between 0.9 and 1.3, preferably 0.9 and 1.15, and most preferably between 0.95 and 1.08. Preferably only Activated alumina may be used to remove both carbon dioxide and water. The adsorbent material may also be a mixed adsorbent which may be a combination of Activated Alumina, X zeolite and/or silica gel and/or A zeolite.

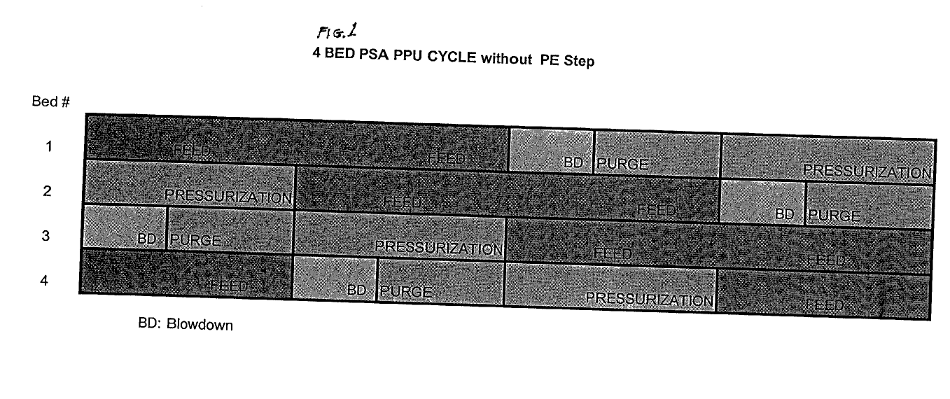

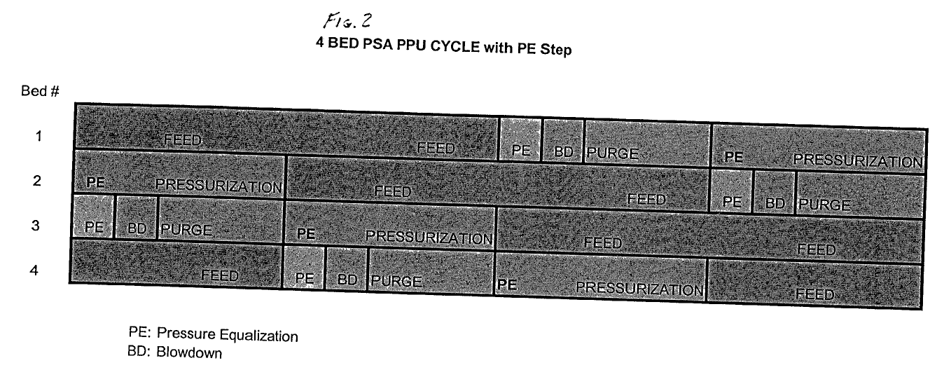

The improved PSA PPU process of the present invention is shown schematically in FIGS. 1 through 9. FIGS. 1 and 2 represent a four bed PSA PPU cycle without and with an added pressure equalization step. Each bed will cycle through the steps of feed with air, blowdown from high to ambient pressures, purge with waste gas from the cryogenic distillation unit and repressurization from ambient to high feed pressure. When the added step of pressure equalization is employed, the constant product flow rate is maintained for the repressurization such that the product flow rate is maintained constant at all times during the cycle. Also, if the added step of pressure equalization is not employed, the constant product flow rate is maintained for the repressurization such that the product flow rate is maintained constant at all times during the cycle.

The adsorption step of the present invention can be carried out at any of the usual and well-known pressures employed for gas phase pressure swing adsorption processes. This pressure envelope may vary widely but is dependent upon the pressure at which adsorption takes place as well as the pressure at which desorption of the gas occurs. Typically this range is about 20 bara in the adsorption step to about 0.05 bara in the purge step with a range of about 10 bara to about 0.15 bara preferred and a range of about 6 bara to about 1 bara is most preferred.

The temperature at which the process is carried out will typically range from about 5° C. to about 35° C. for the adsorption step, however, temperatures as high as 200° C. can be employed.

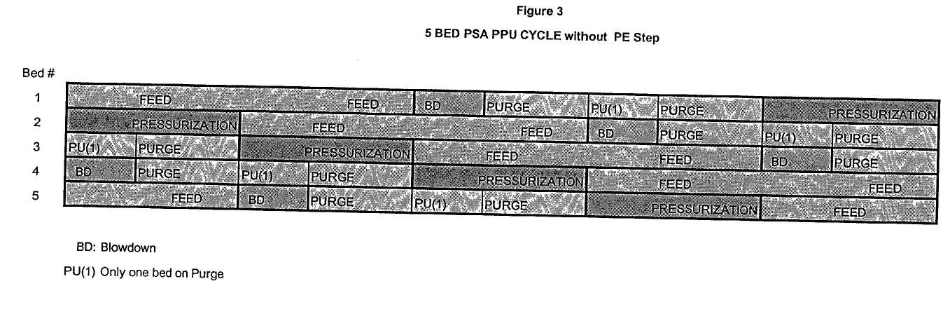

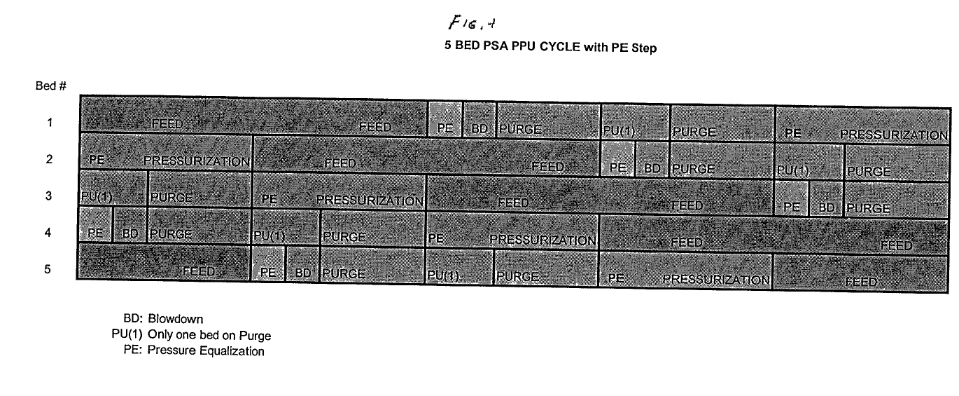

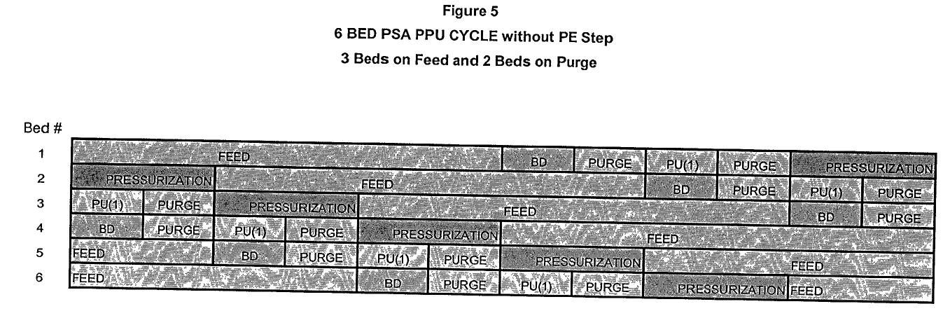

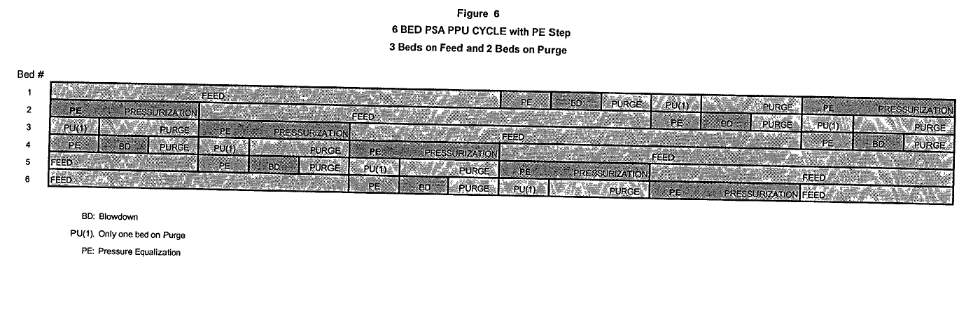

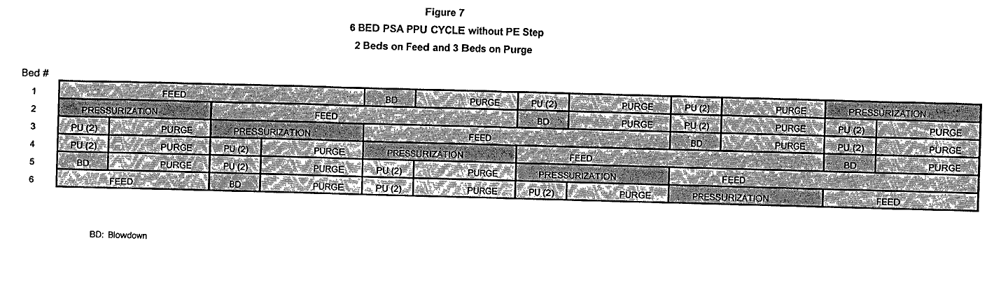

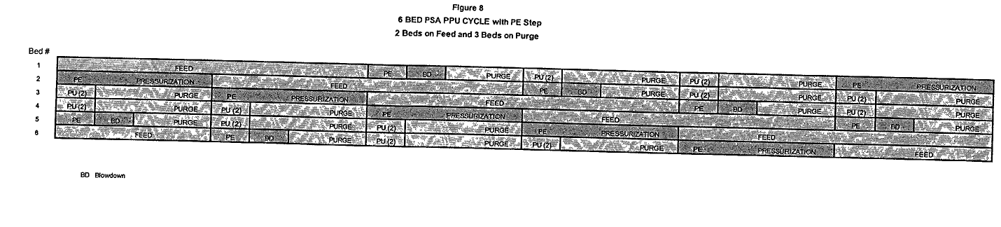

As demonstrated in FIGS. 3 and 4, the step of purging each bed is accomplished in the three connected but discrete steps. The purge is actually begun on two beds at once, followed by a single bed purge and then a two bed purge again. This phenomena is also seen in FIGS. 5 and 6 where a six bed cycle is shown with three beds being simultaneously fed with two beds being purged together. FIGS. 7 and 8, though, describe schematically a six bed PSA PPU where two beds are being fed while three beds are purged. Accordingly, in this cycle, the cycle is feed, blowdown, three bed purge, two bed purge, three bed purge, two bed purge and three bed purge prior to pressure equalization and/or repressurization.

The following table represents design calculations for a five bed PSA PPU system operating under the inventive process (FIG. 3).

TABLE I
PSA PPU Design
450 Metric Tons Per Day O₂ Plant

| | | |
|---|---|---|
| Feed Pressure | 6 | bara |
| Feed Temperature | | ambient |
| No. of Beds | 5 | |
| Diameter | 3.9 | m |
| Vessel (T-T) | 2.1 | m |
| Adsorbent | 16,826 | kg/bed |
| Feed Time | 960 | sec/bed w/2 beds on-line |
| Blowdown Time | 60 | sec/bed |
| Purge Time | 900 | sec/bed w/2 beds on-purge |
| Pressurization Time | 480 | sec/bed |

The following table demonstrates a valve sequence for a pressure swing adsorption pre-purification unit process with five beds without a pressure equalization step, as configured per FIG. 3. An O represents a fully open valve, OP is a valve open to a set position and OPI is a valve open to a different set position.

TABLE II

| | | | | | | | REPRESSUR- | | | | | PURGE AND BLOW- | | | | |
|---|---|---|---|---|---|---|---|---|---|---|---|---|---|---|---|---|
| TIME | PURGE | FEED AIR VALVES | | | | | IZATION VALVES | | | | | DOWN VALVES | | | | |
| (Sec.) | 401 | 101 | 102 | 103 | 104 | 105 | 301 | 302 | 303 | 304 | 305 | 201 | 202 | 203 | 204 | 205 |
| 0-60 | OP | O | | | | O | | O | | | | | | O | OP | |
| 60-480 | OP1 | O | | | | O | | O | | | | | | O | O | |
| 480-540 | OP | O | O | | | | | | O | | | | | | O | OP |
| 540-960 | OP1 | O | O | | | | | | O | | | | | | O | O |
| 960-1020 | OP | | O | O | | | | | | O | | OP | | | | O |
| 1020-1440 | OP1 | | O | O | | | | | | O | | O | | | | O |
| 1440-1500 | OP | | | O | O | | | | | | O | O | OP | | | |
| 1500-1920 | OP1 | | | O | O | | | | | | O | O | O | | | |
| 1920-1980 | OP | | | | O | O | O | | | | | | O | OP | | |
| 1980-2400 | OP1 | | | | O | O | O | | | | | | O | O | | |

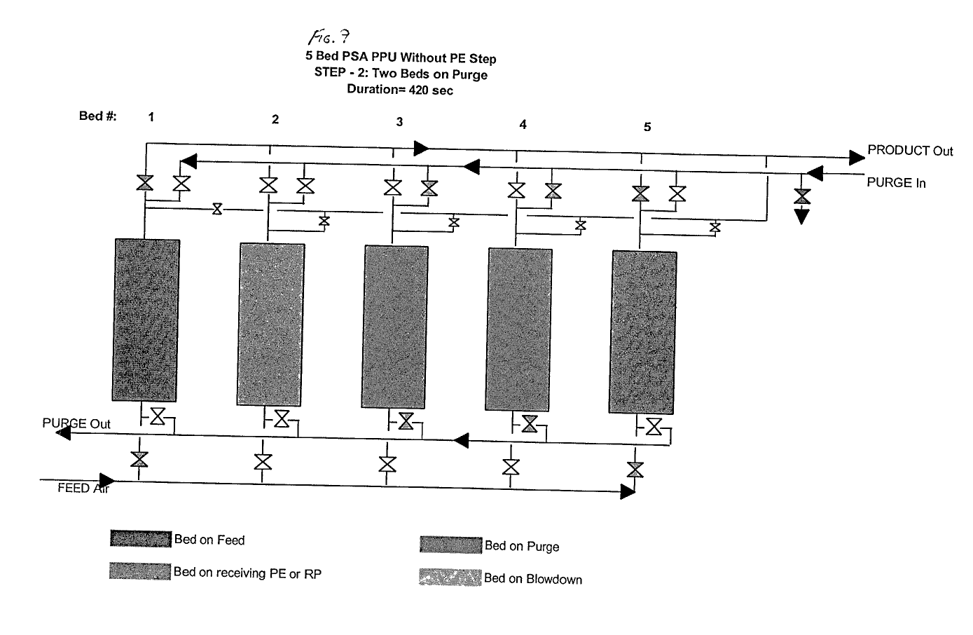

With additional reference to FIG. 9, a pressure swing adsorption pre-purification process without a pressure equalization step is shown. Five beds, 100, 200, 300, 400 and 500 are shown. The cycle begins with feed of air at high pressure to beds 100 and 500 through open valves 101 and 105, respectively. Bed 200 is repressurized through open valve 302 as open valve 202 had allowed for the bed 200 to be purged prior to its repressurization with waste or purge gas. Beds 300 and 400 are purged through valve 203 and blowndown through valve 204, both of which are open. Purge valve 401 remains open fully or at a fixed, open position throughout the cycle.

As the cycle continues, valve 102 is open after repressurization and bed 200 is fed with air. The third bed 300 is being repressurized through open valve 303 while the fourth bed 400 is purged through open valve 204. Feed to bed 500 is then stopped and bed 500 is blowndown through open valve 205. Feed continues to bed 200 and starts for bed 300. Bed 400 begins repressurization through open valve 304 and bed 500 is purged through open valve 205.

As bed 500 is purged through open valve 205, bed 100 begins blowdown through valve 201. Beds 300 and 400 are fed with air through open valves 103 and 104 and bed 500 begins repressurization through valve 305. As the cycle completes itself, beds 400 and 500 are fed with air through valves 104 and 105 as bed 100 begins repressurization through open valve 301. Bed 200 is purged while bed 300 is blowndown and then purged. When bed 100 is finished with repressurization, the cycle starts anew with bed 100 receiving a fresh feed of air. The advantages of this inventive cycle can be seen in that repressurization of at least one bed is occurring throughout the cycle.

While the invention has been described in conjunction with the specific embodiment described above, it is evident that many variations, alterations and modifications will be apparent to those skilled in the art in light of the foregoing description. Accordingly, it is intended to embrace all such alteration, modification and variations that fall within the scope and spirit of the appended claims.

Having thus described the invention, what we claim is:

1. A pressure swing adsorption process for removing carbon dioxide and water vapor from a feed gas comprising introducing said feed gas through at least four beds of adsorbent such that each bed undergoes an operational cycle of steps in phase, of feed, blowdown, purge and repressurization, wherein repressurization is continuous through said beds during each cycle and purified feed gas is produced.

2. The process as claimed in claim 1 wherein from four to eight beds are present.

3. The process as claimed in claim 1 wherein said feed gas is air.

4. The process as claimed in claim 1 wherein said purified feed gas is fed to a cryogenic distillation unit.

5. The process as claimed in claim 1 wherein said adsorbent is selected from the group consisting of activated alumina, silica gel and type X zeolite.

6. The process as claimed in claim 5 wherein said adsorbent is a mixture of adsorbents.

7. The process as claimed in claim 5 wherein said X zeolite is an NaX zeolite with an Si/Al elemental ratio between 0.9 and 1.3.

8. The process as claimed in claim 7 wherein said NaX zeolite has an Si/Al elemental ratio between 0.9 and 1.15.

9. The process as claimed in claim 7 wherein said NaX zeolite has an Si/Al elemental ratio between 0.95 and 1.08.

10. The process as claimed in claim 1 further comprising pressure equalization prior to said blowdown step.

11. The process as claimed in claim 1 wherein said purified feed gas is not vented to the atmosphere.

12. The process as claimed in claim 4 wherein said purified feed gas is fed to said cryogenic distillation unit at a constant rate.

13. The process as claimed in claim 4 wherein said purge uses waste gas from said distillation unit as the purge gas.

14. The process as claimed in claim 1 wherein said feed gas pressure is about 6 bara.

15. The process as claimed in claim 1 wherein said blowdown is from about 6 bara to ambient pressures.

16. The process as claimed in claim 1 wherein five beds are present.

17. The process as claimed in claim 16 wherein said purge step comprises the steps of two bed purge, one bed purge, and two bed purge.

18. The process as claimed in claim 1 wherein six beds are present.

19. The process as claimed in claim 18 wherein said purge step comprises the steps of three bed purge, two bed purge, three bed purge, two bed purge and three bed purge.
